(19) United States
(12) Patent Application Publication
(10) Pub. No.: US 2017/0103061 A1
(43) Pub. Date: Apr. 13, 2017

(54) INTERACTION APPARATUS AND METHOD

(71) Applicant: KABUSHIKI KAISHA TOSHIBA, Tokyo (JP)

(72) Inventor: Yuka Kobayashi, Seto Aichi (JP)

(21) Appl. No.: 15/387,296

(22) Filed: Dec. 21, 2016

Related U.S. Application Data
(63) Continuation of application No. PCT/JP2015/059009, filed on Mar. 18, 2015.

(30) Foreign Application Priority Data
Sep. 18, 2014 (JP) 2014-189995

(51) Int. Cl. G06F 17/27; G10L 15/26; G06K 9/46; G10L 15/22

(52) U.S. Cl. CPC G06F 17/2785; G10L 15/22; G06F 17/2755; G06F 17/274; G10L 15/26; G06F 17/2775; G06K 9/4671; G10L 2015/223

(57) ABSTRACT

According to one embodiment, an interaction apparatus includes an acquirer, an estimator, an extractor, a selector and a controller. The acquirer acquires a text describing an intention of a user. The estimator estimates the intention from the text. The extractor extracts a keyword from the text. The selector selects a word having a part of speech from the text if the keyword having an attribute does not exist in the text when the keyword is to be assigned to a slot, the slot including information relating to the attribute and part of speech of a word necessary to execute a service corresponding to the intention. The controller assigns the selected word to the slot.

### CROSS-REFERENCE TO RELATED APPLICATIONS

This application is a Continuation application of PCT Application No. PCT/JP2015/059009, filed Mar. 18, 2015 and based upon and claiming the benefit of priority from Japanese Patent Application No. 2014-189995, filed Sep. 18, 2014, the entire contents of which are incorporated herein by reference.

### FIELD

Embodiments described herein relate generally to an interaction apparatus and method.

### BACKGROUND

in a terminal such as a computer, cellular phone, and the like, text can be acquired not only by means of keyboard entry, but also by means of character recognition based on handwriting using a touch panel or speech recognition. There is an interaction system to interpret the text acquired in this way, and provide a service corresponding to the interpretation of the text. There is the possibility of new words being daily added to the text to be input to the interaction system, and hence it is difficult for the interaction system to always interpret all the words of the text to be input to the interaction system. Thus, when an unknown word is input, it is necessary for the system to be taught by the user about the word.

As a technique of adding words, there is a method that carries out a procedure in which if a speech recognition result is erroneous, and when the user selects the erroneously recognized part, recognition candidates for the part are presented, and then the user selects a correct solution, whereby the erroneously recognized part is corrected. Besides, as another technique, there is a technique that carries out a procedure in which when speech translation is to be carried out, an example similar to the speech recognition result is retrieved, contents of the slot in the example are replaced with a word in the speech recognition result, and the replaced part is shaded and presented to the user.

### BRIEF DESCRIPTION OF THE DRAWINGS

FIG. 1 is a block diagram showing an interaction apparatus according to a first embodiment.

FIG. 2 is a view showing an example of keywords stored in a keyword-dictionary storage.

FIG. 3 is a view showing an example of data to be stored in a service DB according to the first embodiment.

FIG. 4 is a flowchart showing an interaction operation according to the first embodiment.

FIG. 5 is a view showing a specific example of an interaction operation according to the first embodiment.

FIG. 6 is a view showing an example of data to be stored in a service DB according to a second embodiment.

FIG. 7 is a block diagram showing an interaction apparatus according to a third embodiment.

FIG. 8 is a flowchart showing an interaction operation according to the third embodiment.

FIG. 9 is a view showing a first specific example of the interaction operation according to the third embodiment.

FIG. 10 is a view showing a second specific example of the interaction operation according to the third embodiment.

FIG. 11 is a view showing a specific example of an interaction operation according to a fourth embodiment.

FIG. 12 is a view showing a first specific example of a keyword assignment method according to a fifth embodiment.

FIG. 13 is a view showing a second specific example of the keyword assignment method according to the fifth embodiment.

FIG. 14 is a view showing a keyword assignment, method which displays a list of slots.

FIG. 15 is a block diagram showing an interaction apparatus according to a sixth embodiment.

FIG. 16 is a view showing a specific example of an interaction operation according to the sixth embodiment.

FIG. 17 is a flowchart showing an interaction operation according to a seventh embodiment.

FIG. 18 is a view showing a specific example of the interaction operation according to the seventh embodiment.

### DETAILED DESCRIPTION

In the above-mentioned interaction system, there is sometimes a case where even when a correct interpretation can be carried out in the speech recognition processing, the text cannot be correctly interpreted at the text interpretation processing of post-processing. In such a case, the text itself is correctly displayed, and hence the user cannot understand what is incorrect, and cannot correct the incorrect point. Besides, in the technique of shading the replaced part, when there is no word-which can fill the slot, no shading can be done.

In general, according to one embodiment, an interaction apparatus includes an acquirer, an estimator, an extractor, a selector and a controller. The acquirer acquires a text describing an intention of a user. The estimator estimates the intention from the text. The extractor extracts a keyword from the text. The selector selects a word having a part of speech from the text, if the keyword having an attribute does not exist in the text and the keyword is to be assigned to a slot, the slot including information relating to the attribute and part of speech of a word necessary to execute a service corresponding to the intention. The controller assigns the selected word to the slot.

Hereinafter an interaction apparatus and method according to each of the embodiments will be described in detail with reference to the drawings. It should be noted that in the embodiments described hereinafter, parts denoted by identical reference symbols are considered to carry out identical operations, and a duplicate description is appropriately omitted.

### First Embodiment

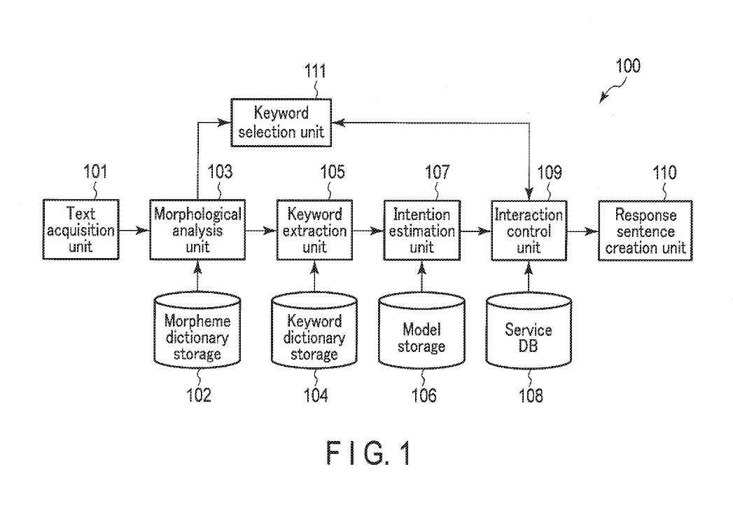

An interaction apparatus according to a first embodiment will be described below with reference to the block diagram of FIG. 1.

The interaction apparatus 100 according to the first embodiment includes a text acquisition unit 101 (acquirer), morpheme dictionary storage 102, morphological analysis unit 103, keyword dictionary storage 104, keyword extraction unit 105, model storage 106, intention estimation unit 107, service DB 108, interaction control unit 109, response sentence creation unit 110, and keyword selection unit 111.

The text acquisition unit 101 acquires text from the user. The text includes a character string which is one or more words.

The morpheme dictionary storage 102 stores therein information necessary for morphological analysis such as a part of speech and reading of a morpheme.

The morphological analysis unit 103 receives text from the text acquisition unit 101, and performs a morphological analysis to the text to thereby obtain a morphological analysis result. The morphological analysis result is, for example, information formed by adding a part of speech, basic form, and reading to each morpheme.

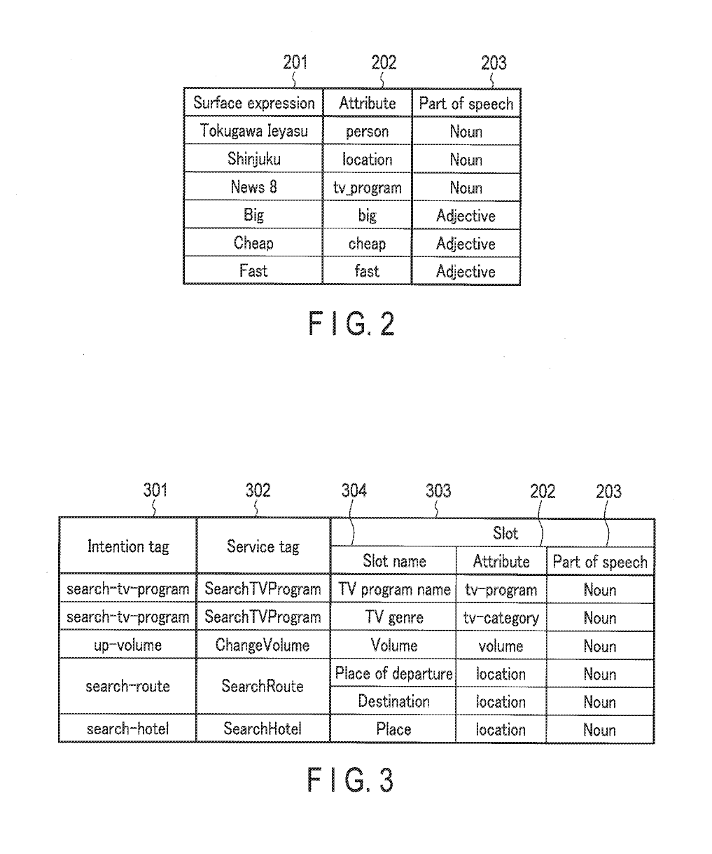

The keyword dictionary storage 104 stores therein a keyword, and attribute of the keyword in such a manner that they are brought into correspondence with each other. The attribute indicates classification of the keyword such as a person, place, TV program, and the like. Details of the keyword dictionary storage 104 will be described later with reference to FIG. 2.

The keyword extraction unit 105 receives the morphological analysis result from the morphological analysis unit 103, and refers to the keyword dictionary storage 104 to thereby extract a keyword, and attribute corresponding to the keyword from the morphological analysis result. It is noted that in a case where no keyword stored in the keyword dictionary storage 104 exists in the morphological analysis result, the case may be treated by considering that there is no keyword to be extracted (the number of keywords to be extracted is zero).

The model storage 106 stores therein intention comprehension models to be used to output the user's intention. Regarding the method of creating an intention comprehension model, it is sufficient if, for example, tags indicating user's intentions and attributes are imparted in advance to a large number of sentences, then morpheme information and keyword information are extracted from the sentences, and an intention comprehension model is created by carrying out machine learning using the extracted morpheme information, and keyword information as a feature value.

The intention estimation unit 107 receives the morphological analysis result from the keyword extraction unit 105 and, when the keyword extraction unit 105 succeeds in extracting a keyword, and attribute corresponding to the keyword, further receives the extracted keyword and attribute therefrom. The intention estimation unit 107 refers to the intention comprehension models stored in the model storage 106 to thereby estimate the user's intention indicating what the user intends to do from the morphological analysis result of the text.

The service DB 108 stores therein services to be executed according to the user's intention, and slots in such a manner that they are brought into correspondence with each other. The slot indicates a combination of information about an attribute of a keyword necessary for execution of a service corresponding to the user's intention, and information about a part of speech of the keyword. Details of the service DB 108 will be described later with reference to FIG. 3.

The interaction control unit 109 receives the user's intention and keyword from the intention estimation unit 107, determines a service to be executed from the user's intention, and determines whether or not keywords to be assigned to the slots are completely prepared. When the keywords are already extracted by the keyword extraction unit 105, and the keywords to be assigned to the slots are completely prepared, the interaction control unit 109 assigns the keywords to the slots. By assigning the keywords to the slots, it is possible to execute a service based on the keywords in the processing of the latter part.

On the other hand, when keywords which can be assigned to the slots are not yet extracted in the keyword extraction unit 105, i.e., when no keywords having attributes corresponding to the attributes included in the slots exist in the text, the interaction control unit 109 creates a selection instruction to cause the keyword selection unit 111 to be described later to select words to be assigned to the slots. Thereafter, the interaction control unit 109 receives the selected words from the keyword selection unit 111, and assigns the words to the slots. In the first embodiment, the case where one word is assigned to one slot is assumed.

The response sentence creation unit 110 receives the slots to which keywords or words are assigned from the interaction control unit 109 to create a response sentence used to prompt the user to determine whether or not a service is to be executed.

The keyword selection unit 111 receives the selection instruction, and morphological analysis result from the interaction control unit 109, and morphological analysis unit 103, respectively, and selects a word having a part of speech corresponding to the part of speech of the slot from the morphological analysis result according to the selection instruction.

Next, an example of keywords to be stored in the keyword dictionary storage 104 will be described below with reference to FIG. 2.

A table 200 shown in FIG. 2 stores therein a surface expression 201, attribute 202, and part of speech 203 in such a manner that they are brought into correspondence with each other. The surface expression 201 indicates surface expression of the keyword. The attribute 202 indicates an attribute of the surface expression 201. The part of speech 203 indicates a part of speech of the surface expression 201.

More specifically, for example, a surface expression 201 “Shinjuku”, attribute 202 “location”, and part of speech 203 “noun” are stored in such a manner that they are brought into correspondence with each other. “Shinjuku” is a place name.

Next, an example of data to be stored in the service DB 108 will be described below with reference to FIG. 3.

A table 300 shown in FIG. 3 stores therein an intention tag 301, service tag 302, and slot 303 in such a manner that they are brought into correspondence with each other. Furthermore, the slot 303 includes a slot name 304, attribute 202, and part of speech 203. The intention tag 301 is a tag indicating the intention of the user. The service tag 302 is a tag indicating the contents of a service to be provided. The slot name 304 indicates the name of the slot. Here, one slot 303 is brought into correspondence with one service tag 302.

More specifically, for example, the intention tag 301 “search-tv-program”, service tag 302 “SearchTVProgram”, slot name 304 “TV program name”, attribute 202 “tv-program”, and part of speech 203 “noun” are stored in such a manner that they are brought into correspondence with each other.

It is noted that the same service tag 302 is operated in a different slot in some cases. For example, although “SearchTVProgram” is a service of carrying out program retrieval, it is possible that there is a case where retrieval is carried out on the basis of the TV program name itself, and a case where retrieval is carried out on the basis of a genre such as “drama”, “music”, and the like. Accordingly, even when the same service tag is used, if there are a plurality of variations of the slot, the service tag is divided into a plurality of pieces for description.

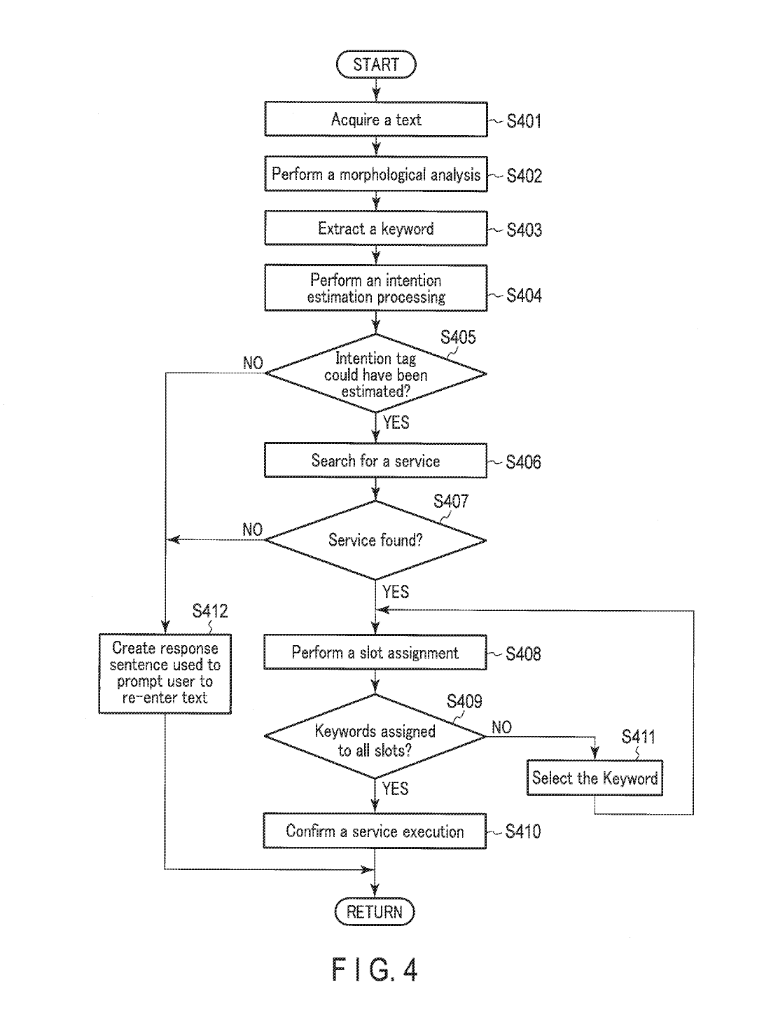

Next, an interaction operation of the interaction apparatus 100 according to the first embodiment will be described below with reference to the flowchart of FIG. 4.

In step S401, the text acquisition unit 101 acquires the text.

In step S402, the morphological analysis unit 103 performs a morphological analysis processing to the text.

In step S403, the keyword extraction unit 105 extracts a keyword from the morphological analysis result.

In step S404, the intention estimation unit 107 performs an estimation processing of the user's intention on the basis of the keyword of step S403.

In step S405, the intention estimation unit 107 determines whether or not an intention tag could have been estimated by the estimation processing of step S404. In the determination, processing of this embodiment, when an intention tag an attribute of which coincides with an attribute of the morphological analysis result exists, it is determined that the intention tag could have been estimated. When the intention tag could have been estimated, the flow proceeds to step S406, and when the intention tag could not have been estimated, the flow proceeds to step S412.

In step S406, the interaction control unit 109 searches for a service to be executed from the service DB 108 in accordance with the intention tag. In this embodiment, a service tag corresponding to the intention tag is retrieved.

In step S407, the interaction control unit 109 determines, on the basis of the retrieval processing of step S406, whether or not a corresponding service exists, i.e., whether or not a service tag corresponding to the intention tag exists. When the service exists (service tag exists), the flow proceeds to step S408, and when no service exists (no service tag exists), the flow proceeds to step S412.

In step S408, the interaction control unit 109 carries out slot assignment. The “slot assignment” is processing to be carried out to assign a keyword to a slot corresponding to the service tag retrieved in step S407.

In step S409, the interaction control unit 109 determines whether or not keywords have been assigned to all the slots. When keywords have been assigned to all the slots, the flow proceeds to step S410, and when keywords have not been assigned to all the slots, the flow proceeds to step S411.

In step S410, the response sentence creation unit 110 creates a confirmation sentence used to prompt the user to confirm the service to be executed when the service is to be executed, and then the interaction operation is terminated. It should be noted that when the confirmation sentence is presented to the user, and thereafter the user consents to the confirmation sentence, the service is executed. Regarding the execution of the service, it is sufficient if general processing is carried out, and hence a description thereof is omitted here.

In step S411, the keyword selection unit 111 selects a word from the text. Thereafter, the flow is returned to step S408, and the same processing is repeated. It is noted that in step S408, the interaction control unit 109 carries out processing of assigning the selected word to the slot.

In step S412, the situation thereof corresponds to the case where the user's intention cannot be estimated or the case where the service cannot be found, and hence the response sentence creation unit 110 creates a response sentence used to prompt the user to re-enter the text so that the text can be re-entered by the user, and thereafter the response sentence is presented to the user. Thus, the interaction operation of the interaction apparatus 100 according to the first embodiment ends.

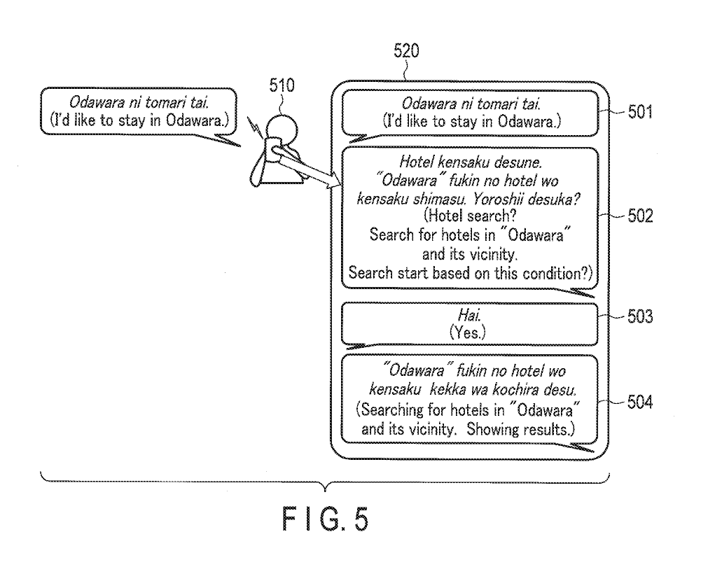

Next, a specific example of the operation of the interaction apparatus 100 according to the first embodiment will be described below with reference to FIG. 5.

In the example of FIG. 5, a case where the user 510 inputs an utterance “Odawara ni tomaritai (I'd like to stay in Odawara.)” terminal such as a cellular phone, tablet PC or the like by voice is assumed. Odawara is a place name. Besides, a case where the word “Odawara” is not stored in the keyword dictionary storage 104 is assumed.

When the user 510 utters an utterance 501 “Odawara ni tomaritai (I'd like to stay in Odawara)”, the text acquisition unit 101 acquires the utterance 501 “Odawara ni tomaritai” as text, and the utterance 501 is displayed on a screen 520. The morphological analysis unit 103 subjects the utterance 501 to morphological analysis, and obtains “Odawara (noun)/ni (particle)/tommari (verb)/tai (auxiliary verb)”. Although the keyword extraction unit 105 tries to extract a keyword, “Odawara” does not exist in the keyword dictionary storage 104, and hence no keyword can be extracted. It is assumed that subsequently, the intention estimation unit 107 estimates an intention of the user, and acquires an intention tag “search-hotel” from the character string “tomaritai”.

The interaction control unit 109 refers to the service DB 108 shown in FIG. 3 to obtain a service tag “SearchHotel” corresponding to the intention tag “search-hotel”. Here, no keyword has been extracted in the keyword extraction unit 105, and hence a keyword having an attribute “location” cannot be assigned to the slot of the service tag “SearchHotel”.

Thus, the keyword selection unit 111 carries out keyword selection. Here, the part of speech of a word corresponding to the condition of the part of speech of the slot is “noun”, and the word the part of speech of which is noun in the utterance 501 “Odawara ni tomaritai” is only one word “Odawara”, and hence the keyword selection unit 111 selects “Odawara”. The interaction control unit 109 assigns the word “Odawara” to the slot of the attribute “location”.

All the keywords have been assigned to the slots, and hence the response sentence creation unit 110 creates a response sentence associated with the service to be provided such as a sentence “Hoteru kennsaku desune. (Hotel search?) ‘Odawara’ fukin no hoteru wo kensakushimasu. (Search for hotels in “Odawara” and its vicinity.) Yoroshii desuka? (Search start based on this condition?)” as an answer 502 from the interaction apparatus 100. The response sentence is displayed on the screen 520.

It is noted that regarding the processing to be carried out thereafter, for example, when the user 510 utters the contents permitting execution, of the service such as an utterance 503 “Hai. (Yes.)”, it is sufficient if processing for executing the service is carried out. As a specific execution example, retrieval processing of the Internet using “Odawara hotel” as a retrieval query carried out, and the system can present a processing result together with a response sentence such as an answer 504 “Odawara fukin no hoteru no kensaku kekka wa kochira desu (Searching for hotels in “Odawara” and its vicinity. Showing results.”

According to the first embodiment described above, even when a word which is not registered in the keyword dictionary is used, it is possible to carry out a smooth interaction by referring to a part of speech to thereby select a word from the text, and assigning the selected word as a keyword of a slot necessary for providing the service.

### Second Embodiment

In the first embodiment, the case where one keyword is assigned to a slot is assumed. However, a second embodiment differs from the first embodiment in that a plurality of keywords are assigned to the slot.

It is noted that an interaction apparatus according to the second embodiment is identical to the interaction apparatus 100 shown in FIG. 1, and hence a description thereof is omitted here.

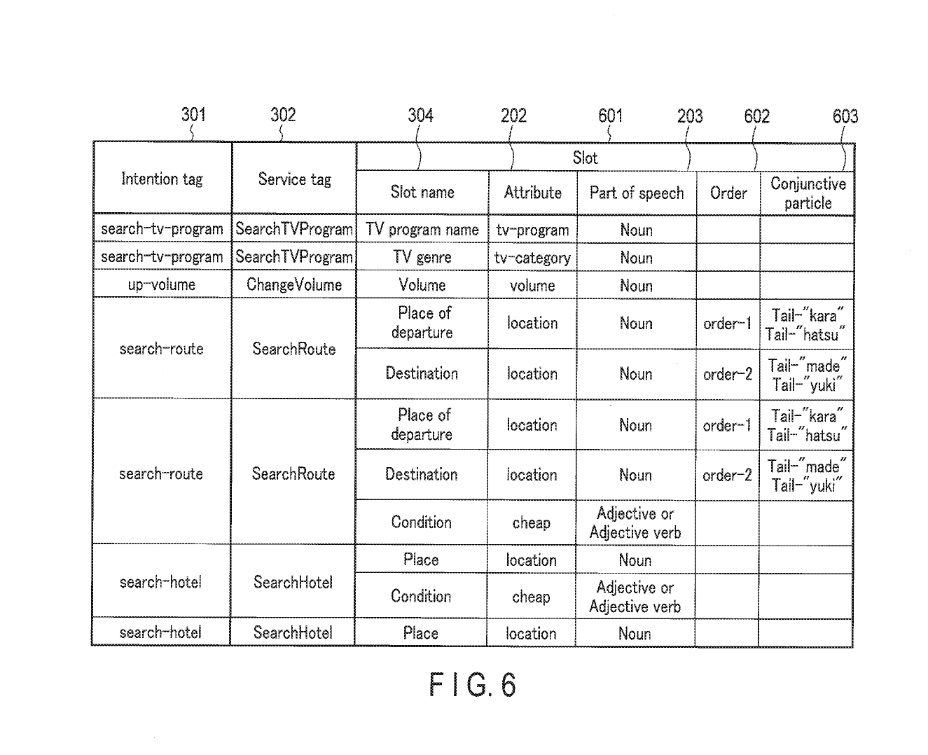

An example of a service DE 108 according to the second embodiment will be described below with reference to FIG. 6.

A table shown in FIG. 6 includes an intention tag 301, service tag 302, and slot 601. The slot 601 includes a slot name 304, attribute 202, part of speech 203, order 602, and conjunctive particle 603.

The order 602 is order in which a keyword necessary for a certain service appears in the text. The conjunctive particle 603 indicates a pattern of a particle to be attached to the keyword. A combination of the attribute 202, part of speech 203, and conjunctive particle 603 or a combination of the attribute 202, part of speech 203, and order 602 becomes a condition for the slot 601.

More specifically, two slots 601 are brought into correspondence with the intention tag 301 “search-route”, and service tag 302 “SearchRoute”. The slot name 304 “place of departure”, attribute 202 “location”, part of speech 203 “noun”, order 602 “order-1”, and conjunctive particles 603 “tail-‘kara’” and “tail-‘hatsu’” are brought into correspondence with the first slot 601. The slot name 304 “destination”, attribute 202 “location”, part of speech 203 “noun”, order 602 “order-2”, and conjunctive particles 603 “tail-‘made’” and “tail-‘yuki’” are brought into correspondence with the second slot 601.

It is noted that when a plurality of patterns are included in the conjunctive particle 603, any one of the patterns may be satisfied. For example, any one of the conjunctive particles 603 “tail-‘kara’” and “tail-‘hatsu’” may be applicable to the case.

Next, specific examples of the operation of the interaction apparatus according to the second embodiment will be described below with reference to FIG. 6.

As a first example, a case where “Odawara” and “yasuku” are not stored in a keyword dictionary storage 104, and text “Odawara ni yasuku ni tomaritai (I'd like to stay in Odawara at a low price.)” is acquired at a text acquisition unit 101 is assumed.

As a morphological analysis result of the text, “Odawara (noun)/ni (particle)/yasuku (adjective)/ni (particle)/tomari (verb)/tai (auxiliary verb)” is obtained by a morphological analysis unit 103. In this case, “Odawara” and “yasuku” are not stored in the keyword dictionary storage 104, and hence a keyword extraction unit 105 cannot extract a keyword. Subsequently, it is assumed that the intention tag 301 “search-hotel” is estimated by an intention estimation unit 107 on the basis of the contents of the text, and an interaction control unit 109 obtains the corresponding service tag 302 “SearchHotel” shown in FIG. 6.

The part of speech 203 corresponding to the attribute 202 “location” of the slot is “noun”, and hence a keyword selection unit 111 selects “Odawara” which is a word in the text, and the part of speech of which is a “noun”. The part of speech. 203 corresponding to the attribute 202 “cheap” of another slot is “adjective or adjective verb”, and hence the keyword selection unit 111 selects “yasuku” which is a word in the text, and the part of speech of which is an “adjective”.

The interaction control unit 109 assigns the selected word. “Odawara” as a keyword of the attribute “location” corresponding to the slot name “place”, and assigns the selected word “yasuku” as a keyword of the attribute “cheap” corresponding to the slot name “condition”. As described above, even when a plurality of slot exist, if the parts of speech of the slots are different from each other, it is possible to assign keywords to the slots.

Next, as a second example, a case where “Kaminoge” and “Odawara” are not stored in the keyword dictionary storage 104, and text “Kaminoge kara Odawara made dou yukeba iino (How can I get to Odawara from Kaminoge?)” is acquired at the text acquisition unit 101 is assumed. “Kaminoge” and “Odawara” are place names.

As a morphological analysis result of the text, “Kaminoge (noun)/kara (particle)/Odawara (noun)/made (particle)/dou (adverb)/yuke (verb)/ba (particle)/ii (adjective)/no (particle)” is obtained by the morphological analysis unit 103. In this case, “Kaminoge” and “Odawara” are not stored in the keyword dictionary storage 104, and hence the keyword extraction unit 105 cannot extract a keyword. Subsequently, it is assumed that the intention tag 301 “search-route” is estimated by the intention estimation unit 107 on the basis of the contents of the text, and the interaction control unit 109 obtains the corresponding service tag 302 “SearchRoute” shown in FIG. 6.

The keyword selection unit 111 selects “Kaminoge” that is a word the part of which is a noun corresponding to the condition of the slot name 304 “place of departure”, i.e., the attribute 202 “location” of the slot, and to which “kara” is added as the conjunctive particle 603 at the end of the word. Likewise, the keyword selection, unit 111 selects “Odawara” that is a word the part of speech of which is a noun satisfying the condition of the slot name “destination”, and to which “made” is added as the conjunctive particle 603 at the end.

The interaction control unit 109 assigns the selected word “Kaminoge” to the slot of the slot name “place of departure” as a keyword, and assigns the selected word “Odawara” to the slot of the slot name “destination” as a keyword.

It should be noted that it is possible to obtain the same result on the basis of the condition of the appearance order. For example, even when the text acquisition unit 101 has acquired the text “Kaminoge Odawara kan wa dou yukeba iino”, it is possible to assign the noun “Kaminoge” appearing firstly as the keyword of the slot of the place of departure on the basis of the order “order-1” which is the condition of the slot name “place of departure”, and assign the noun. “Odawara” appearing secondly as the keyword of the slot of the destination on the basis of the order “order-2” which is the condition of the slot name “destination”.

According to the second embodiment described above, even when a plurality of slots to which keywords are to be assigned exist, it is possible to appropriately select words appearing in the text according to the conditions of the slots, and carry out a smooth interaction.

### Third Embodiment

A third embodiment differs from the aforementioned embodiments in that the user directly enters a character string to be assigned as a keyword by using an input device such as a touch panel, buttons of a remote controller or the like. It should be noted that in the third embodiment, the case where the number of slots which are objects of keyword assignment is one is assumed.

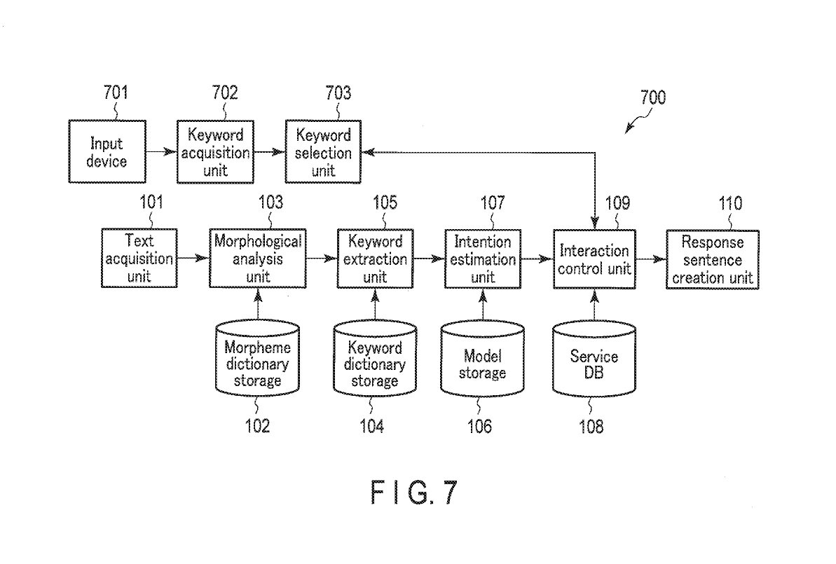

An interaction apparatus according to the third embodiment will be described below with reference to the block diagram of FIG. 7.

The interaction apparatus 700 according to the third embodiment includes a text acquisition unit 101, morpheme dictionary storage 102, morphological analysis unit 103, keyword dictionary storage 104, keyword extraction unit 105, model storage 106, intention estimation unit 107, service DB 108, interaction control unit 109, response sentence creation unit 110, input device 701, keyword acquisition unit 702, and keyword selection unit 703.

The text acquisition unit 101, morpheme dictionary storage 102, morphological analysis unit 103, keyword dictionary storage 104, keyword extraction unit 105, model storage 106, intention estimation unit 107, service DB 108, interaction control unit 109, and response sentence creation unit 110 carry out operations identical to the first embodiment, and hence their detailed descriptions are omitted.

The input device 701 is a device capable of operating a terminal such as a touch panel, buttons of a remote controller or the like, and the user inputs a character string or a stroke to the input device.

The keyword acquisition unit 702 carries out a character recognition processing on the basis of the character string or the stroke from the input device 701, and acquires an input character string which is a character string to be input by using the input device.

The keyword selection unit 703 receives the input character string from the keyword acquisition unit 702, and sends the input character string to the interaction control unit 109 as a keyword.

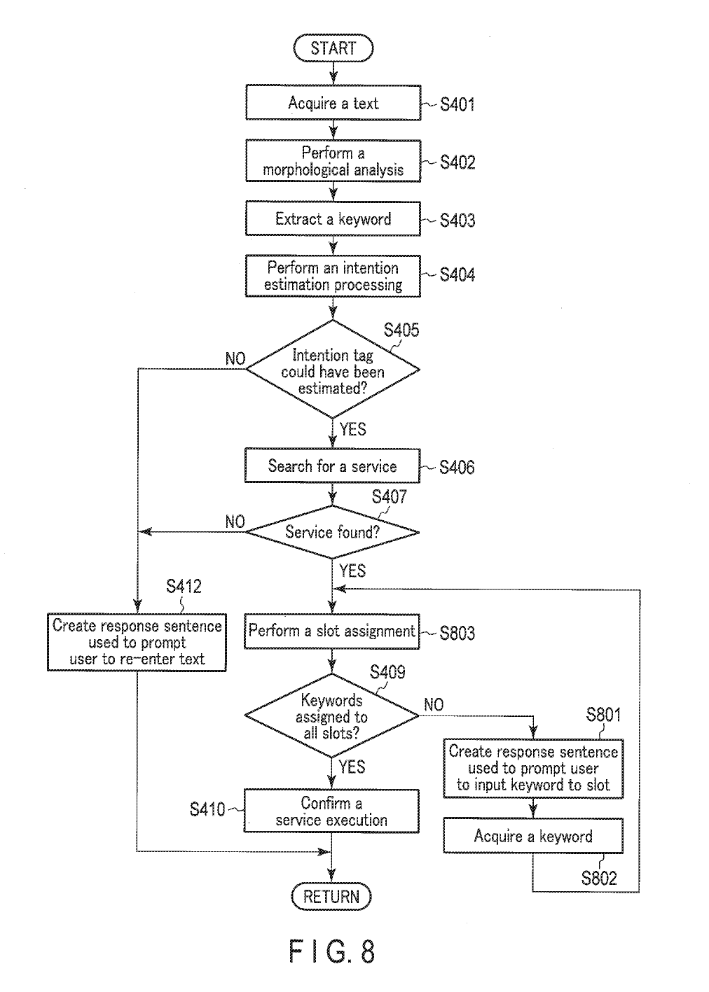

Next, an interaction operation of the interaction apparatus 700 according to the third embodiment will be described below with reference to the flowchart, of FIG. 8.

Operations of steps S401 to S407, step S409, step S410, and step S412 are identical to the flowchart shown in FIG. 4, and hence their descriptions are omitted here.

In step S801, the slot is not filled with the keyword, and hence the response sentence creation unit 110 creates a response sentence used to prompt the user to input a keyword to be assigned to the slot.

In step S802, the keyword acquisition unit 702 acquires the input character string input by the user.

In step S803, the interaction control unit 109 carries out slot assignment to be carried out to assign the input character string to the slot as a keyword.

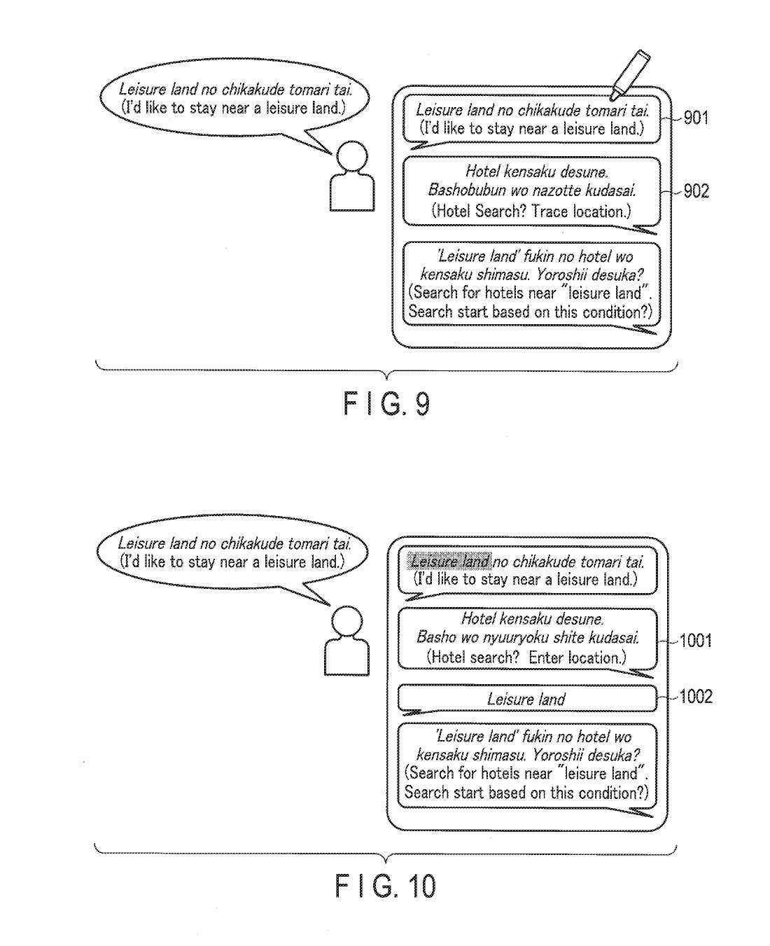

Next, a first specific example of the interaction operation of the interaction apparatus 700 according to the third embodiment will be described below with reference to FIG. 9.

A case where the user utters an utterance “Leisure land no chikakude tomaritai (I'd like to stay near a leisure land)” (utterance 901), and the intention of the utterance is estimated in the interaction apparatus 700, and the word “leisure land” is not stored in the keyword dictionary storage 104 is assumed.

The word “leisure land” is not stored in the keyword dictionary, and hence a keyword is not extracted. Thus, no keyword can be assigned to the slot, and hence “Hotel kensaku desune. Bashobubun wo nazotte kudasai. (Hotel Search? Trace location.)” (answer 902) is created by the response sentence creation unit 110 as a response sentence used to prompt the user to input a keyword by using the input device 701, and the created response sentence is displayed on the screen.

The user selects the word “Leisure land” which is a part of the text by tracing the part “Leisure land” corresponding to the keyword of the slot by using the input device 701.

Here, the user carries out marking on the character string “Leisure land” by using the input device 701 provided with a user interface having an edit function such as a marking pen or the like. The keyword acquisition unit 702 acquires the part “Leisure land” traced by the user as an input character string.

The interaction control unit 109 assigns the input character string “Leisure land” acquired by the keyword acquisition unit 702 to the slot as a keyword.

The interaction apparatus 700 may not take the morphological analysis result into consideration. Even when the morphological analysis result is associated with a plurality of words or only a part of a word, it is sufficient if the input character string is treated as a keyword. Accordingly, not only when the keyword is not registered in the keyword dictionary storage 104, but also when the morphological analysis meets with failure, it is possible to carry out slot assignment by means of the interaction apparatus 700 according to the third embodiment.

Instead of designating a keyword to be assigned to slot by using the input device 701, an input from the user acquired by the text acquisition unit 101 may be acquired as a keyword.

A second specific example of the operation of the interaction apparatus 700 according to the third embodiment will be described below with reference to FIG. 10. In FIG. 10, as in the case of FIG. 9, a case where the user utters an utterance “Leisure land no chikakude tomaritai (I'd like to stay near a leisure land)” is assumed.

The word “Leisure land” is not stored in the keyword dictionary storage 104, and hence a keyword is not extracted. Thus, “Hotel kensaku desune. Basho wo nyuuryoku shite kudasai. (Hotel search? Enter location.)” (answer 1001) is created as a response sentence used to prompt the user to input text, and the created response sentence is presented to the user.

In response to the presented response sentence, the user inputs the word “Leisure land” as text 1002. Thereby, the text acquisition unit 101 may acquire “Leisure land” as an input character string, and may send the input character string to the keyword selection unit 703.

According to the third embodiment described above, by assigning the input character string designated by the user by using the input device to the slot as a keyword, it is possible to advance a smooth interaction by using an appropriate keyword.

### Fourth Embodiment

In a fourth embodiment, a case where keywords are assigned to a plurality of slots on the basis of keyword designation carried out by the user, and the condition of the slot to which the keyword is to be assigned is assumed.

An interaction apparatus according to the fourth embodiment has a configuration identical to the interaction apparatus 700 according to the third embodiment, and hence a description thereof is omitted here.

A specific example of an interaction, operation of the interaction apparatus according to the fourth embodiment will be described below with reference to FIG. 11.

In FIG. 11, a case where the user utters an utterance “Leisure land kara Fashion tower made douyatte ikuno (Show me how to get to fashion tower from leisure land)” (utterance 1101), and “Leisure land” and “Fashion tower” are not stored in a keyword dictionary storage 104 is assumed.

The words “Leisure land” and “Fashion tower” are not stored in the keyword dictionary, and hence a keyword is not extracted in a keyword extraction unit 105. Thus, a response sentence creation unit 110 creates “Keiro kensaku desune, shuppatsuchi to mokutekichi we nazotte kudasai. (Route search? Trace departure place and destination.)” (answer 1102) as a response sentence used to prompt the user to input text by using an input device 701, and the answer 1102 is presented to the user.

In response to the presented response sentence, the user designates “Leisure land” and “Fashion tower” by using the input device 701. Regarding the method of designation, it is sufficient, as in the case of the third embodiment, if marking is carried out on the words “Leisure land” and “Fashion tower” by using a marker which is the input device. A keyword acquisition unit. 702 acquires “Leisure land” and “Fashion tower” as input character strings.

Regarding the conditions of the slots shown in FIG. 6, the slot name 304 “place of departure” imposes the condition that “kara” should be attached to the end of the name as a conjunctive particle 603, and the slot name 304 “destination” imposes the condition that “made” should be attached to the end of the name as a conjunctive particle 603. Accordingly, in order that “Leisure land” and “Fashion tower” can satisfy the conditions, “Leisure land” is assigned to the slot “place of departure”, and “Fashion tower” is assigned to the slot “destination”.

According to the fourth embodiment described above, it is possible to appropriately assign keywords to the slots, and advance a smooth interaction on the basis of the keywords designated by the user by using the input device, and conditions of the slots.

### Fifth Embodiment

In a fifth embodiment, keyword selection of a case where a plurality of slots exist, and keywords to be assigned cannot be narrowed down even when determination is carried out on the basis of the conditions of the slots will be described.

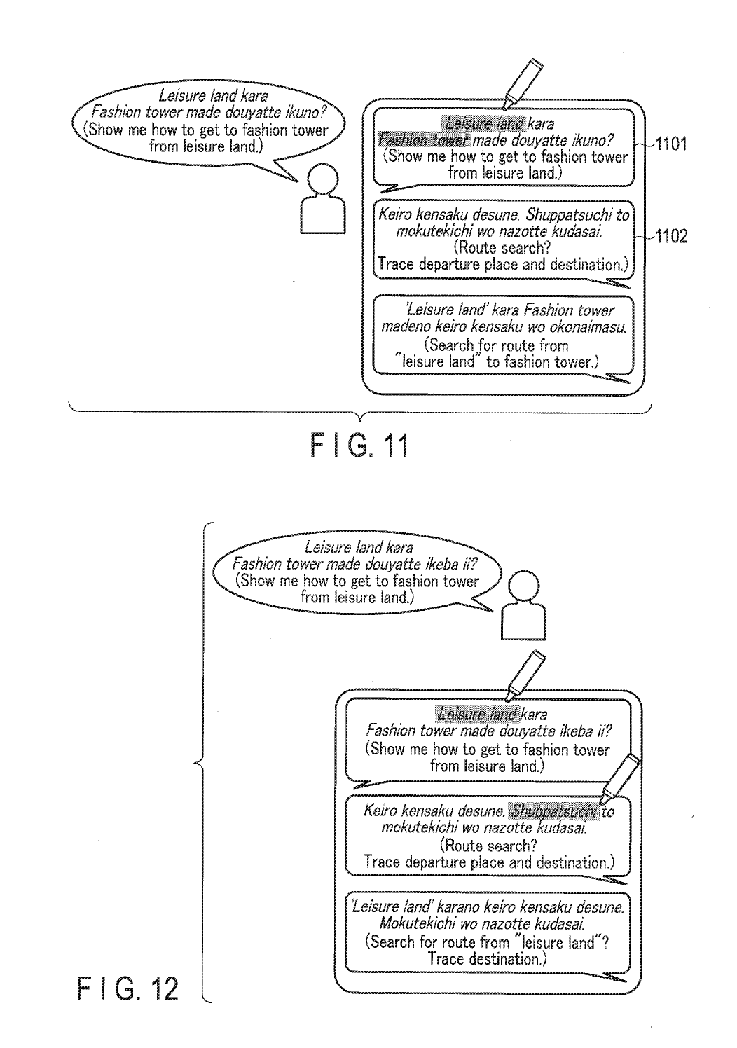

A first specific example of a keyword assignment method of an interaction apparatus according to the fifth embodiment will be described below with reference to FIG. 12.

In FIG. 12, as in the case of FIG. 11, a case where the user utters an utterance “Leisure land kara. Fashion tower made douyatte ikuno”, and “Leisure land” and “Fashion tower” are not stored in a keyword dictionary storage 104 is assumed.

As shown in FIG. 12, when, after tracing “Leisure land” by using an input device, the user traces the “Shuppatsuchi” (place of departure) which is the slot name in the response sentence in the stage in which keywords are to be designated, a keyword acquisition unit 702 acquires “Leisure land” as an input character string. An interaction control unit 109 assigns the input character string “Leisure land” to the slot of the “place of departure” as a keyword.

Likewise, when, after tracing “Fashion tower”, the user traces the character string “Mokutekichi” (destination) which is the slot name in the response sentence, the keyword acquisition unit 702 acquires “Fashion tower” as an input character string. The interaction control unit 109 assigns the input character string “Fashion tower” to the slot of the “destination” as a keyword.

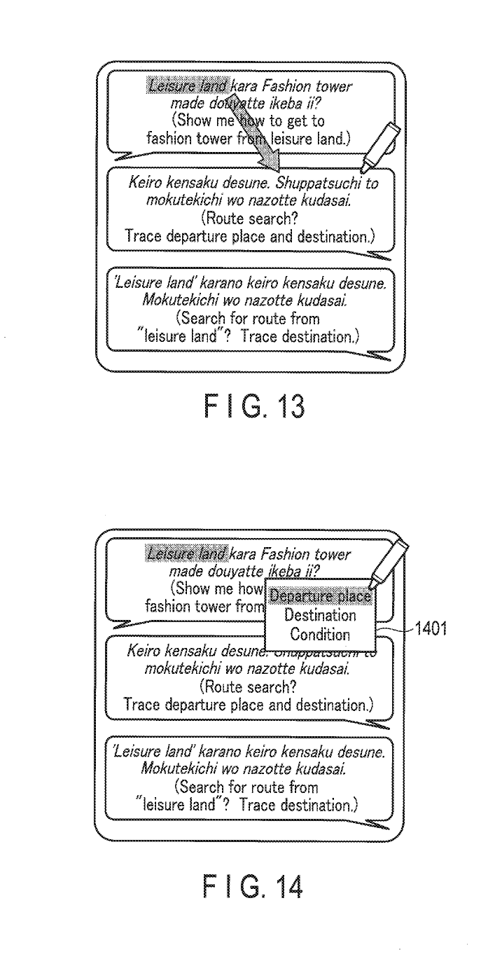

A keyword may be assigned to the slot by another method of designation. A second specific example of the keyword assignment method will be described below with reference to FIG. 13.

The user traces “Leisure land”, and thereafter draws an arrow from “Leisure land” to “place of departure” in the response sentence, whereby the interaction control unit 109 may assign “Leisure land” to the slot of “place of departure”. Likewise, the user traces “Fashion tower”, and thereafter draws an arrow from “Fashion tower” to “destination” in the response sentence, whereby the interaction control unit 109 may assign “Fashion tower” to the slot of “destination”. The direction of the arrow may be reversed. For example, “Leisure land” may be assigned to the slot of “place of departure” by tracing “place of departure” and thereafter drawing an arrow from “place of departure” to “Leisure land”.

Besides, a list of slots may be displayed, and the user may be made to select a slot for assignment. An example of display of a list of slots is shown in FIG. 14.

As shown in FIG. 14, a list 1401 of slots including “place of departure”, “destination”, and “condition” as a plurality of slot names is displayed. The user selects one the slots from the list 1401, whereby it is possible to assign an input character string even to a slot not included in the response sentence. For example, as the slots to be brought into correspondence with the service tag 302 “SearchRoute” shown in FIG. 6, the slot name “condition” is included in some cases in addition to the slot names 304 “place of departure” and “destination”. Accordingly, by displaying the three types of slot names as the list 1401, it is possible to assign the input character string as a keyword even to the slot name “condition” not existing in the response sentence.

According to the fifth embodiment described above, even when a plurality of slots exist, and the slots to which keywords are to be assigned cannot be narrowed down, it is possible to assign keywords to the plurality of slots, and perform a smooth interaction by making the user designate keywords, and slots to which the keywords should be assigned.

### Sixth Embodiment

In a sixth embodiment, a case where a text acquisition unit 101 carries out speech recognition or handwriting recognition to thereby acquire text will be described.

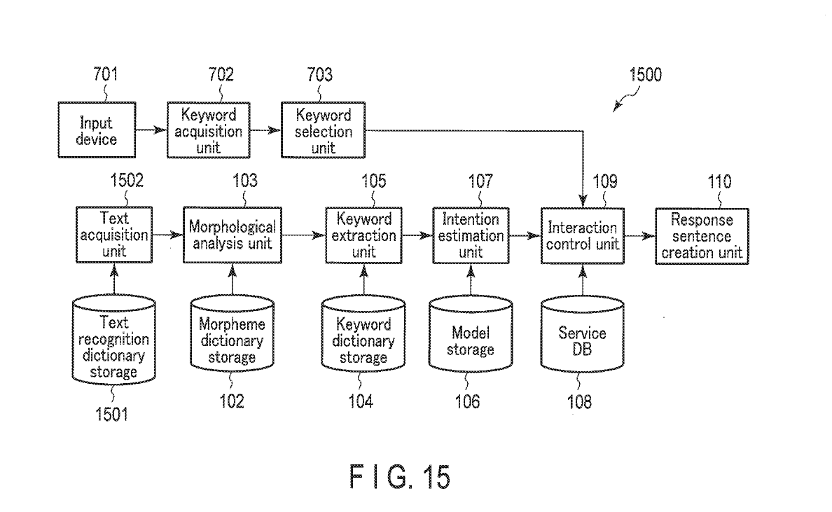

An interaction apparatus according to the sixth embodiment will be described below with reference to the block diagram of FIG. 15.

The interaction apparatus 1500 according to the sixth embodiment includes a morpheme dictionary storage 102, morphological analysis unit 103, keyword dictionary storage 104, keyword extraction unit 105, model storage 106, intention estimation unit 107, service DE 108, interaction control unit 109, response sentence creation unit 110, input device 701, keyword acquisition unit 702, keyword selection unit 703, text recognition dictionary storage 1501, and text acquisition unit 1502.

The morpheme dictionary storage 102, morphological analysis unit 103, keyword dictionary storage 104, keyword extraction unit 105, model storage 106, intention estimation unit 107, service DE 108, interaction control unit 109, response sentence creation unit 110, input device 701, keyword acquisition unit 702, and keyword selection unit 703 carry out processing identical to the aforementioned embodiments, and hence their descriptions are omitted here.

The text recognition dictionary storage 1501 stores therein correspondence between voice data associated with speech recognition processing and a character string, and correspondence between a stroke and character string.

The text acquisition unit 1502 acquires input of voice or a stroke from the user, and refers the text recognition dictionary storage 1501 to thereby recognize the input voice or stroke, and obtain, the corresponding text. After acquiring the text, the processing identical to the aforementioned embodiments may be carried out.

It is noted that in the speech recognition or handwriting recognition processing, there are sometimes cases where a recognition error occurs.

In such a case, not only a candidate the likelihood of which is the highest in the recognition result of the recognition processing, but also candidates the likelihood of which is the second highest or lower may be presented in the N-best form, and some of the candidates may be presented in descending order of likelihood in the recognition result.

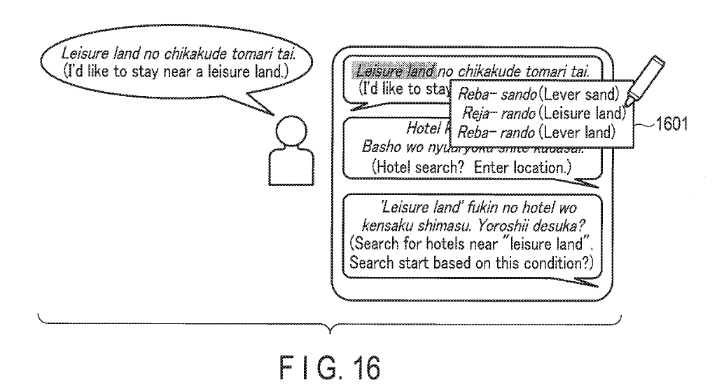

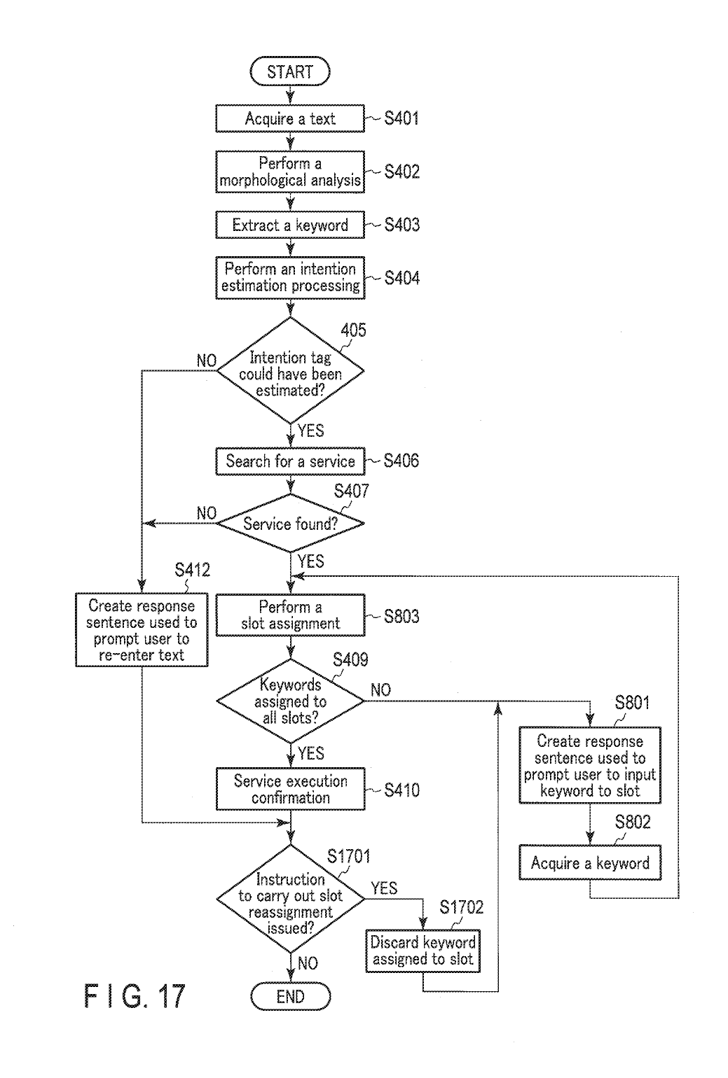

A specific example of an operation of the interaction apparatus 1500 according to the sixth embodiment will be described below with reference to FIG. 16.

In FIG. 16, it is assumed that the user utters an utterance “Leisure land no chikakude tomaritai (I'd like to stay near a leisure land.)”, and an erroneous speech recognition result “Reba-sando no chikakude tomaritai (I'd like to stay near a lever sand)” is obtained. At this time, when the user traces “Lever sand” as a keyword to be assigned to the slot, in addition to “Lever sand” the likelihood of which is the highest in the speech recognition result, “Leisure land” and “Lever land” the likelihoods of which are the second highest and lower are also displayed in the list 1601 as character string candidates. By carrying out such an operation, t is possible, when a word expected by the user is included in the list 1601, it is possible that the word expected by the user is selected.

According to the sixth embodiment described above, even when false recognition occurs in the speech recognition and handwriting recognition, it is possible, if the user selects a correct character string from the list, to assign the correct character string to the slot, and perform a smooth interaction.

### Seventh Embodiment

In a seventh embodiment, a case where a slot assigned by the interaction apparatus is wrong is assumed.

An interaction apparatus according to the seventh embodiment is identical to the aforementioned embodiments, and hence a description thereof is omitted here.

An operation of the interaction apparatus according to the seventh embodiment will be described below with reference, to the flowchart of FIG. 17. In the operations of steps other than step S1701 and step S1702, processing identical to FIG. 8 is carried out, and hence their descriptions are omitted here.

In step S1701, an intention estimation unit 107 determines whether or not an instruction to carry out reassignment of a slot has been issued. When an instruction to carry out reassignment of a slot has been issued, the flow proceeds to step S1702, and when no instruction to carry out reassignment of a slot has been issued, the processing is terminated.

In step S1702, an interaction control unit 109 discards the keyword which has been assigned to the slot. Thereafter, the flow proceeds to step S801, and identical processing is carried out.

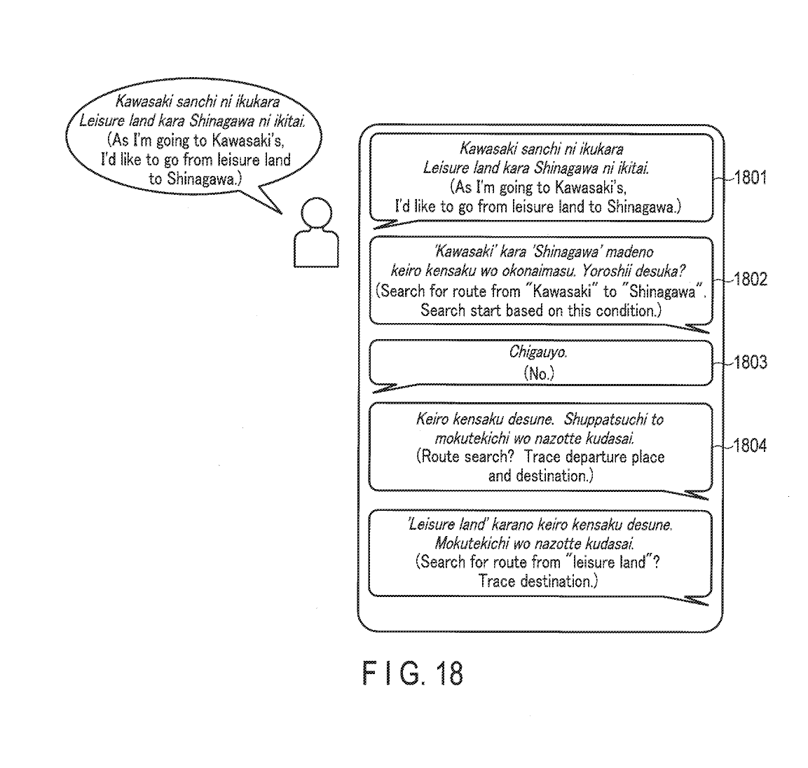

Next, a specific example of the interaction operation of the interaction apparatus according to the seventh embodiment will be described below with reference to FIG. 18.

In the example of FIG. 18, a case where the user utters an utterance “Kawasaki sanchi ni ikukara, Leisure land kara Shinagawa ni ikitai (As I'm going to Kawasaki's, I'd like to go from leisure land to Shinagawa.)” (utterance 1801) is assumed. In this case, “Kawasaki” is a family name, and “Shinagawa” is a place name.

A case where the system carries out processing for the utterance 1801, and makes an answer “‘Kawasaki’ kara ‘Shinagawa’ made no keiro kensaku wo okonaimasu. Yoroshii desuka? (Search for route from “Kawasaki” to “Shinagawa”. Search start based on this condition.)” (answer 1802) is assumed. In this case, ‘Kawasaki’ assigned as a place of departure of route retrieval is not a name of a place, but a person's name, and hence is a wrong result of route retrieval.

Thus, when the user utters an utterance “Chigauyo (No)” (utterance 1803) in order to correct the keyword assigned to the slot, the intention estimation unit 107 estimates that the utterance is an instruction to carry out reassignment of the slot, and the interaction control unit 109 discards the keyword assigned to the current slot.

Thereafter, a response sentence creation unit 110 creates a response sentence “Keiro kensaku desune, shuppatsuchi to mokutekichi wo nazotte kudasai (Route search? Trace departure place and destination.)” (answer 1804) used to reassign a keyword to the slot, and the answer 1804 is presented to the user. Here, “Leisure land” is traced, whereby the interaction control unit 109 assigns “Leisure land” to the slot “destination” as a keyword.

According to the seventh embodiment described above, even when a wrong keyword is assigned to the slot, it is possible to carry out correction by the operation of the user, and perform a smooth interaction.

In the above-mentioned embodiments, a combination of a keyword and attribute of a slot by which the user has agreed to the execution of a service, and the recognition result selected by the user as the correct answer may be learned, and stored in the dictionary, and the stored information may be made available when the same word is input again next time.

For example, in the example of the first embodiment, when the service is executed with respect to the word “Odawara” which has not existed in the keyword dictionary storage 104 as shown in FIG. 5, it can be considered that correct slot assignment has been carried out. Thus, in order to register a word assigned to a slot for which the service has been executed as a keyword, it is sufficient if the word assigned to the slot, and the attribute are stored in the keyword dictionary storage 104 in such a manner that they are brought into correspondence with each other. When “Odawara” is uttered by the user next time, the keyword extraction, unit 105 can extract “Odawara” from the keyword dictionary storage 104 as a keyword. By virtue of learning of the recognition result described above, smooth interaction can be carried out.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart, block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An interaction apparatus, comprising:
an acquirer that acquires a text describing an intention of a user;
an estimator that estimates the intention from the text;
an extractor that extracts a keyword from the text;
a selector that selects a word having a part of speech from the text, if the keyword having an attribute does not exist in the text and the keyword is to be assigned to a slot, the slot including information relating to the attribute and part of speech of a word necessary to execute a service corresponding to the intention; and
a controller that assigns the selected word to the slot.

2. The apparatus according to claim 1, wherein
the selector selects one word when the one word which includes the part of speech corresponding to the part of speech included in the slot exists in the text.

3. The apparatus according to claim 1, wherein
when a plurality of keywords are to be assigned to the slot, the slot further includes information relating to at least one of an order in which the keywords appear, and a conjunctive particle indicating a pattern of a particle to be added to each of the keywords, and
the selector selects a word corresponding to at least one of the part of speech, and the order and conjunctive particle.

4. The apparatus according to claim 1, wherein
the controller learns a correspondence between a word assigned to the slot, and the attribute included in the slot.

5. An interaction apparatus, comprising:
a first acquirer that acquires a text describing an intention of a user;
an estimator that estimates the intention from the text;
an extractor that extracts a keyword from the text;
a creator that create, if the keyword having an attribute does not exist in the text when the keyword is to be assigned to a slot, a first response sentence used to prompt the user to input, the slot including information relating to the attribute and part of speech of a word necessary to execute a service corresponding to the intention;
a second acquirer that acquires an input character string to be input from the user by using an input device; and
a controller that assigns the input character string to the slot.

6. The apparatus according to claim 5, wherein
the second acquirer acquires a part of the text selected by using the input device as the input character string.

7. The apparatus according to claim 5, wherein
the creator creates a second response sentence having a slot name of the slot,
the second acquirer acquires, when the slot name of the second response sentence is designated and a part of the text is designated by using the input device, the part of the text as the input character string, and
the controller assigns the input character string to the slot corresponding to the designated slot name.

8. The apparatus according to claim 7, wherein
the second acquirer acquires, in one of a case were tracing is carried out from part of the text to the slot name by using the input device, and a case where tracing is carried out from the slot name to the part of the text by using the input device, the part of the text as the input character string.

9. The apparatus according to claim 7, wherein
the second acquirer acquires, when one slot name is selected from among a plurality of slot names displayed as a list, the part of the text as the input character string.

10. The apparatus according to claim 1, further comprising a storage that stores a correspondence between voice data associated with a speech recognition processing, and a character string, wherein
the acquirer carries out the speech recognition processing with respect to an utterance of the user by referring to the correspondence, and obtains character string candidates in the N-best form in descending order of likelihood in the speech recognition processing as a speech recognition result.

11. The apparatus according to claim 1, further comprising a storage that stores a correspondence between a stroke and a character string, wherein
the acquirer carries out a handwriting recognition processing with respect to a stroke input from the user by referring to the correspondence, and obtains character string candidates in the N-best form in descending order of likelihood in the handwriting recognition processing as a handwriting recognition result.

12. The apparatus according to claim 1, wherein
the estimator estimates an instruction to carry out reassignment to the slot, and
the controller discards, when the instruction to carry out reassignment is issued, the keyword assigned to the slot.

13. An interaction method, comprising:
acquiring a text describing an intention of a user;
estimating the intention from the text;
extracting a keyword from the text;
selecting a word having a part of speech from the text, if the keyword having an attribute does not exist in the text and the keyword is to be assigned to a slot, the slot including information relating to the attribute and part of speech of a word necessary to execute a service corresponding to the intention; and
assigning the selected word to the slot.

14. The method according to claim 13, wherein
the selecting selects one word when the one word which has the part of speech corresponding to the part of speech included in the slot exists in the text.

15. The method according to claim 13, wherein
when a plurality of keywords are to be assigned to the slot, the slot further includes information relating to at least one of an order in which the keywords appear, and a conjunctive particle indicating a pattern of a particle to be added to each of the keywords, and
the selecting selects a word corresponding to at least one of the part of speech, and the order and conjunctive particle.

16. The method according to claim 13, further comprising learning a correspondence between a word assigned to the slot, and the attribute included in the slot.

17. The method according to claim 13, further comprising storing, in a storage, a correspondence between voice data associated with a speech recognition processing, and a character string, wherein
the acquiring carries out the speech recognition processing with respect to an utterance of the user by referring to the correspondence, and obtains character string candidates in the N-best form in descending order of likelihood in the speech recognition processing as a speech recognition result.

18. The method according to claim 13, further comprising storing, in a storage, a correspondence between a stroke and a character string, wherein
the acquiring carries out a handwriting recognition processing with respect to a stroke input from the user by referring to the correspondence, and obtains character string candidates in the N-best form in descending order of likelihood in the handwriting recognition processing as a handwriting recognition result.

19. The method according to claim 13, wherein
the estimating estimates an instruction to carry out reassignment to the slot, and the method further comprising discarding, when the instruction to carry out reassignment is issued, the keyword assigned to the slot.

20. A non-transitory computer readable medium including computer executable instructions, wherein the instructions, when executed by a processor, cause the processor to perform a method comprising:
acquiring a text describing an intention of a user;
estimating the intention from the text;
extracting a keyword from the text;
selecting a word having a part of speech from the text, if the keyword having an attribute does not exist in the text and the keyword is to be assigned to a slot, the slot including information relating to the attribute and part of speech of a word necessary to execute a service corresponding to the intention; and
assigning the selected word to the slot.
